(19) United States
(12) Patent Application Publication
(10) Pub. No.: US 2014/0085106 A1
(43) Pub. Date: Mar. 27, 2014

(54) VEHICLE PROXIMITY WARNING SYSTEM AND METHODS

(71) Applicant: CHECKERS INDUSTRIAL PRODUCTS, LLC, Broomfield, CO (US)

(72) Inventors: Scott Clifford, Mesa, AZ (US); Steven N.D. Brundula, Chandler, AZ (US)

(73) Assignee: Checkers Industrial Products, LLC, Broomfield, CO (US)

(21) Appl. No.: 13/791,498

(22) Filed: Mar. 8, 2013

Related U.S. Application Data
(60) Provisional application No. 61/704,263, filed on Sep. 21, 2012.

(51) Int. Cl. G08G 1/16

(52) U.S. Cl. CPC G08G 1/16
USPC 340/903

(57) ABSTRACT

A vehicle proximity warning system includes a first device carried by a first vehicle and comprising a first transceiver and a first warning device, and a second device carried by a second vehicle and comprising a second transceiver and a second warning device. The first device determines proximity of the first vehicle relative to the second vehicle and generates a warning signal with the first warning device when the proximity is within a first predetermined distance. The second device determines proximity of the second vehicle relative to the first vehicle and generates a warning signal with the second warning device when the proximity is within a second predetermined distance.

### RELATED APPLICATION

This claims the benefit of U.S. Provisional Application No. 61/704,263, filed on 21 Sep. 2012, which is hereby incorporated by reference herein in its entirety.

### BACKGROUND

In the mining industry, such as open pit mines, large haul trucks are used to carry product from the point of digging to another location for transport or processing of the mined materials. Haul trucks are typically significantly larger than pickup trucks and other vehicles commonly used in and around a mine. In some haul trucks, the driver sits at a position 15 ft. to 20 ft. above ground, and the tires of the truck may range in size from 10 ft. to 14 ft. in height. It is not uncommon for haul trucks to run over smaller vehicles because of the limited view of the driver of the haul truck of objects that are in close proximity to the haul truck.

Government standards have been enacted in an effort to reduce the number of accidents involving haul trucks and smaller vehicles. One such standard is that small vehicles used in proximity to haul trucks must carry a whip or lighting system, which provide increased visibility for the smaller vehicles. A whip is an elongate flexible rod that extends vertically upward from the vehicle. The lighting may include a strobe light. The lighting may be positioned at any location on the vehicle, and may even be carried at a free end of the whip.

Another regulation is that all haul trucks and vehicles in use around haul trucks must carry a two-way radio so that the vehicle drivers can readily communicate with each other.

However, even with these extra precautions, it is sometimes difficult if not impossible for the driver of a haul truck to see a smaller vehicle that is in close proximity to the haul truck. Thus, opportunities exist for providing improved identification of smaller vehicles in proximity to haul trucks.

### SUMMARY

As will be described in greater detail below, the instant disclosure generally relates to a vehicle proximity warning system. The system includes a first device carried by a first vehicle and comprising a first transceiver and a first warning device. The system also includes a second device carried by a second vehicle and comprising a second transceiver and a second warning device. The first device determines proximity of the first vehicle relative to the second vehicle and generates a warning signal with the first warning device when the proximity is within a first predetermined distance. The second device determines proximity of the second vehicle relative to the first vehicle and generates a warning signal with the second warning device when the proximity is within a second predetermined distance.

The first and second warning signals may be one of a light, an audible noise, and a text or symbol on a display screen. The second transceiver may be positioned in a whip carried by the second vehicle. The first predetermined distance may be in the range of about 50 ft. to about 100 ft. The first and second transceivers may generate and receive one of a global position system (GPS) signal and a radio signal. A signal generated by the first and second transceivers may include identification information about the first and second vehicles, respectively. The first device may determine a proximity of the first vehicle relative to the second vehicle when the second vehicle is located out of view of a driver of the first vehicle.

Another aspect of the present disclosure relates to a vehicle proximity warning system that includes first and second devices. The first device is configured to be carried by a first vehicle and comprises at least a receiver, a microcontroller, and a warning device. The second device is configured to be carried by a second vehicle and comprises at least a transmitter configured to transmit a signal unique to the second vehicle. The receiver is configured to receive the signal, the microcontroller is configured to determine whether the second vehicle is within a predetermined distance relative to the first vehicle based on the signal, and the warning device generates a warning signal when the second vehicle is determined to be within the predetermined distance.

The warning signal may include identification information about the second vehicle. The second device may be configured to be carried by a whip, which is mounted to the second vehicle. The signal may be a radio signal. The signal may be a global position system (GPS) signal and the first device plots a position of the second vehicle on a display. The first device may include a display, the display showing information about proximity of the second vehicle to the first vehicle. The first device may include a transmitter configured to transmit a signal to the second device. The second device may be configured to be carried by a light fixture, which is mounted to the second vehicle.

A further aspect of the present disclosure relates to a method of determining proximity between at least first and second vehicles. The method includes providing a first device having at least a receiver, a microcontroller, and a warning device, and a second device having at least a transmitter, generating a first signal with the second device and transmitting the first signal, receiving the first signal with the receiver, determining a proximity of the second vehicle to the first vehicle with the microcontroller, and operating the warning device to generate a warning signal when proximity of the second vehicle is within a predetermined distance relative to the first vehicle.

The first signal may be unique to the second vehicle. The warning signal may be at least one of a light, an audible noise, and a text or symbol shown on a display. The first device may include a transmitter, the second device may include a receiver, a microcontroller and a warning device, and the method further includes generating a second signal with the first device and t ransmitting the second signal, receiving the second signal with the receiver of the second device, determining a proximity of the first vehicle to the second vehicle with the microcontroller of the second device, and operating the warning device of the second device to generate a warning signal when the first vehicle is within a predetermined distance relative to the second vehicle.

The second signal may be unique to the first vehicle. The method may include positioning the transmitter in a whip, which is carried by the second vehicle. The method may include transmitting the first signal as a radio signal.

Features from any of the above-mentioned embodiments may be used in combination with one another in accordance with the general principles described herein. These and other embodiments, features and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram showing an example vehicle proximity warning system in accordance with the present disclosure.

FIG. 2 is a block diagram showing a pair of vehicles that carry portions of the vehicle proximity warning system of FIG. 1.

FIG. 3 shows a plurality of vehicles carrying portions of the vehicle proximity warning system of FIG. 1, wherein the vehicles are at different positions relative to each other.

FIG. 4 is a block diagram showing components of an example device of the vehicle proximity warning system of FIG. 1.

FIG. 5 is a block diagram showing components of another example device of the vehicle proximity warning system of FIG. 1.

FIG. 6 is a block diagram showing components of a variation of the device of FIG. 5.

FIG. 7 is a flow diagram showing an example method in accordance with the present disclosure.

FIG. 8 is a flow diagram showing another example method in accordance with the present disclosure.

FIG. 9 depicts a block diagram of a computer system suitable for implementing the present systems and methods.

FIG. 10 is a block diagram depicting a network architecture in which system clients, as well as storage servers, are coupled to a network.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, one of skill in the art will understand that the exemplary embodiments described herein are not intended to be limited to the particular forms disclosed. Rather, the instant disclosure covers all modifications, equivalents, and alternatives falling within the scope defined by the appended claims.

### DETAILED DESCRIPTION OF EXEMPLARY EMBODIMENTS

As will be described in greater detail below, the present disclosure relates generally to communication between vehicles, and more particularly relates to determining proximity between vehicles based on communication signals between the vehicles. One aspect of the present disclosure is directed to a vehicle proximity warning system that provides a warning to the driver of a first vehicle when at least one other vehicle comes within a predetermined distance of the first vehicle. In one example, the vehicle proximity warning system includes a receiver associated with the first vehicle and a transmitter associated with the two or more other vehicles, and the receiver of the first vehicle receives signals generated by the transmitters of the other vehicles. The system uses the received signal to determine a proximity of the first vehicle relative to the other vehicles. The system may generate a warning to the driver of at least one of the vehicles when any of the other vehicles moves within a predetermined distance of the first vehicle. The warning may include at least one of a light, an audible noise, and text or symbols displayed for viewing by the driver. The driver may then have the option of changing the course of the first vehicle or communicating with the drivers of the other vehicles to request a change of course of the other vehicles.

In another embodiment, the vehicle proximity warning system provides a separate device in each vehicle, wherein each device includes at least a transceiver, a microprocessor, and a warning device. Each of the devices sends and receives signals and determines, using the microprocessor, a proximity of the other vehicles relative to the vehicle carrying that device. The warning device may then provide a warning to the driver when one of the other vehicles moves within a predetermined distance of the vehicle in which the driver is driving. The driver may then have the option of changing the course of the vehicle being driven, or communicate with the drivers of the other vehicles (e.g., via a two-way radio) to request a change of course of the other vehicles.

The signals generated by the vehicle proximity warning system may encode identification information about the vehicle from which the signal originates. In some examples, the signal is a radio signal and the vehicle proximity warning system utilizes a received signal strength indicator (RSSI) pin commonly found in most industry manufactured transceivers. The strength of the RSSI pin supplies an analog voltage proportional to the received signal strength, which is entered into a microcontroller for determining the approaching vehicle's relative location. Determining an approaching vehicle's relative position may be determined continuously to provide real-time indications of relative proximity of multiple vehicles.

In another example, the signal is a GPS-related signal, and the location of a plurality of vehicles is plotted on a display screen. The position of the vehicles on the display screen may be updated continuously to show the driver not only the position of other vehicles, but the direction of movement of the other vehicles relative to each other.

Another aspect of the present disclosure relates to a master control center in which a position of a plurality of vehicles is monitored at a remote location from the vehicles (e.g., at a stationary control center). An operator of the system at the control center may monitor the proximity of multiple vehicles (e.g., a fleet of haul trucks), relative to other vehicles and provide warnings to drivers as needed when the vehicles come into relatively close proximity to each other (e.g., within a predetermined distance).

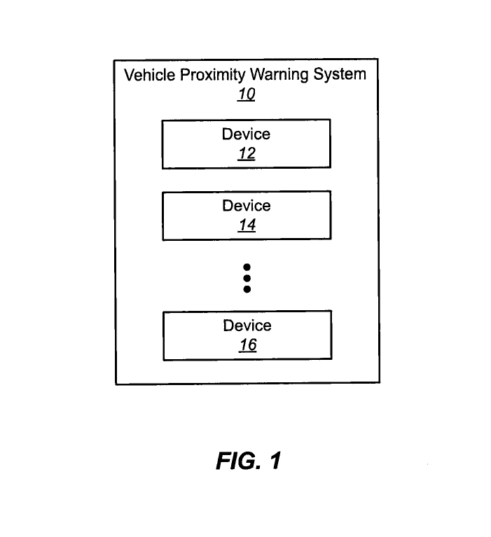

FIG. 1 is a block diagram showing schematically a vehicle proximity warning system 10. The vehicle proximity warning system 10 may include a plurality of devices that are carried by separate vehicles. The devices may include, for example, a device 12, a device 14, and a device 16. The devices 12, 14, 16 may have different components and functionality. In one example, the device 12 is configured to receive signals transmitted by the devices 14, 16, and may use the received signals to determine proximity of the devices 14, 16 relative to the device 12. In at least some examples, the devices 14, 16 do not receive signals or determine a relative proximity to other devices. In another example, each of the devices 12, 14, 16 sends and receives signals and is operable to determine relative proximity to other devices and their associated vehicles.

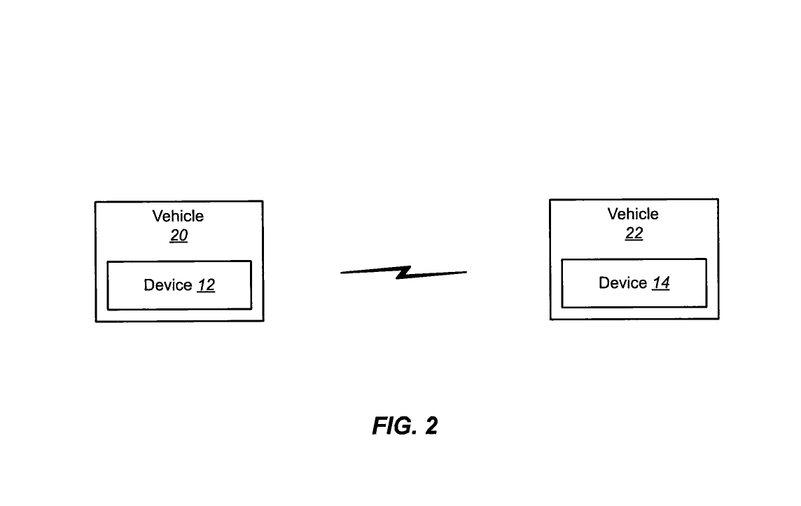

FIG. 2 shows the device 12 carried by vehicle 20 and the device 14 carried by vehicle 22. The devices 12, 14 are part of the vehicle proximity warning system 10 described above. The vehicle proximity warning system 10 may be configured for one-way communication from device 12 to device 14, or vice versa. Alternatively, the vehicle proximity warning system 10 may be configured for two-way communication between the devices 12 and 14. In a one-way communication system, the device 12 is able to determine the location of vehicle 20 relative to vehicle 22, but device 14 is not able to determine the proximity of vehicle 22 relative to vehicle 20. In a two-way communication system, the device 12 operates to determine the proximity of vehicle 22 relative to vehicle 20, and device 14 is operable to determine the proximity of vehicle 20 relative to vehicle 22.

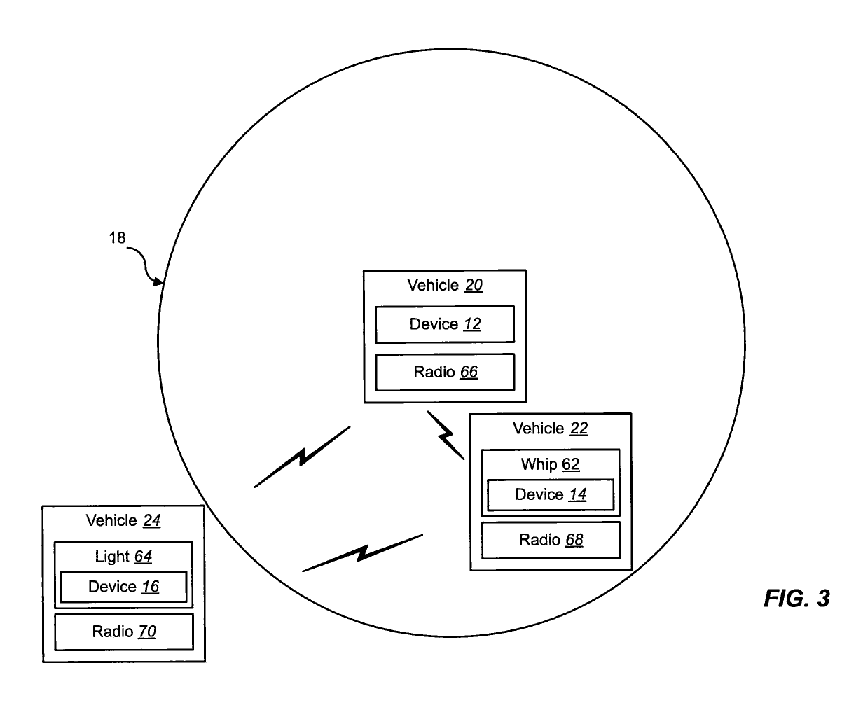

Other scenarios are possible including one in which three or more vehicles each carry a separate device of the vehicle proximity warning system 10. FIG. 3 shows the device 12 of vehicle 20 communicating with the device 14 of vehicle 22 and device 16 of vehicle 24. One-way or two-way communication may be possible between the device 12 and each of the devices 14, 16. In still further embodiments, one or two-way communication may be possible between device 14 and device 16.

FIG. 3 shows a perimeter 18 around the device 12 and associated vehicle 20. The perimeter 18 may define a predetermined distance around the device 12 used for triggering a warning signal to the driver of vehicle 20. If one of the devices 14, 16 moves within the perimeter 18, the device 12 generates a warning signal. The driver of vehicle 20 then has the option of changing a course of direction of vehicle 20 to avoid vehicles 22 and 24, or communicate with the drivers of vehicles 22 and 24 via radios 66, 68, 70 to request a change of course for vehicles 22, 24.

The devices 12, 14, 16 may be carried by vehicles 20, 22, 24, respectively, at any desired location on the vehicle. In at least one example, the vehicle 22 includes a whip 62, and the device 14 is mounted to the whip 62. In some examples, the whip 62 includes a light fixture at a distal end thereof. The device 14 may be mounted to, within, or adjacent to the light fixture carried by whip 62. Device 14 may draw power from a power source that powers the light fixture carried by whip 62. The device 16 may be mounted to, within, or adjacent to a light 64 of the vehicle 24. The light 64 may be positioned in any desired location such as, for example, on a roof of the vehicle 24. The light 64 may include, for example, a strobe light. The device 16 may draw power from the same power source used to operate light 64.

Alternatively, the devices 12, 14, 16 may be positioned within a cab or at another location inside or outside of the vehicles 20, 22, 24. In some arrangements, portions of the devices 12, 14, 16 are positioned internally within the vehicle (e.g., a display screen or warning device) and other portions of the devices 12, 14, 16 are positioned external the cab of the vehicle (e.g., on a whip or an externally mounted light fixture).

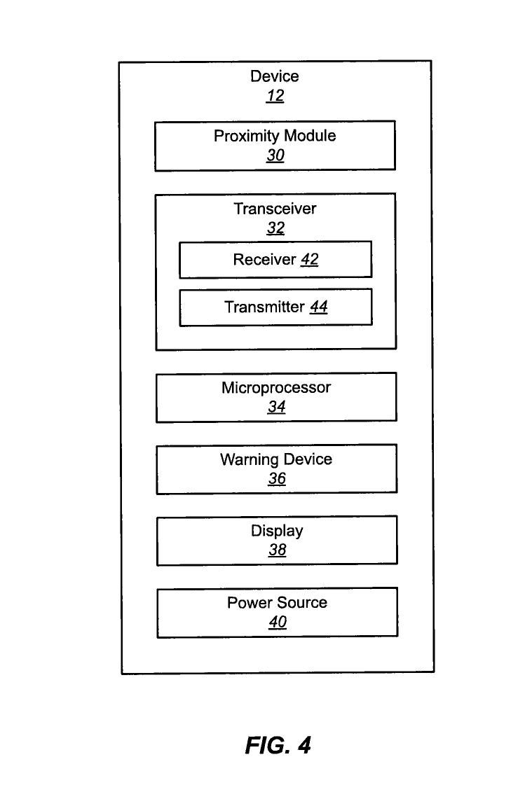

FIG. 4 shows a block diagram showing example components of device 12. The device 12 may be carried by, for example, a haul truck. Device 12 may include a proximity module 30, a transceiver 32 having receiver 42 and transmitter 44 components, a microprocessor 34, a warning device 36, a display 38, and a power source 40. The proximity module 30 may be operated using the microprocessor 34 to determine proximity of other vehicles to the vehicle that is carrying device 12. The proximity module 30 may receive signals from a plurality of different devices of the vehicle proximity warning system, which are associated with different vehicles, and perform a separate determination or calculation of the proximity of each vehicle. The proximity module 30 may comprise memory and may communicate with other devices. For example, the proximity module 30 may communicate with the warning device 36 or display 38 for delivering information to the driver about a determined proximity of other vehicles.

The transceiver 32 may include one or both of receiver 42 and transmitter 44 depending on whether the vehicle proximity warning system 10 is set up as a one-way or two-way communication system with other devices. The signals sent by transmitter 44 may include, for example, identification information about the vehicle that carries device 12 or a GPS signal. The signals may also include warning information and proximity information.

The warning device 36 may provide communication with the driver concerning proximity of other vehicles. The warning device 36 may generate or operate, for example, a light, an audible noise, or the display of text or symbols on a monitor or other display 38. The warning generated by warning device 36 may include identification information about the vehicle that is in close proximity such as, for example, an identification code, a driver name, a vehicle type, or contact information for reaching the driver via, for example, a radio, cell phone, or other communications device.

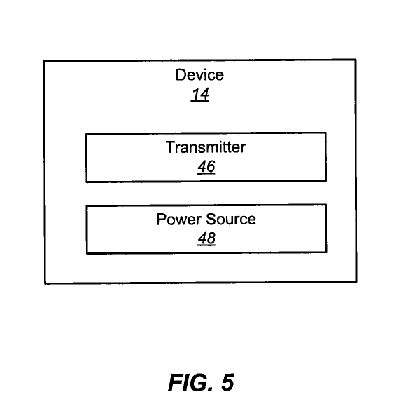

FIG. 5 shows an example device 14 including a transmitter 46 and a power source 48. The device 14 may be particularly suited for one-way communication with device 12. Device 14 provides transmission of a signal via transmitter 46. The signal is received by the receiver 42 of device 12. The signal transmitted by transmitter 46 may include, for example, identification information about the vehicle carrying device 14.

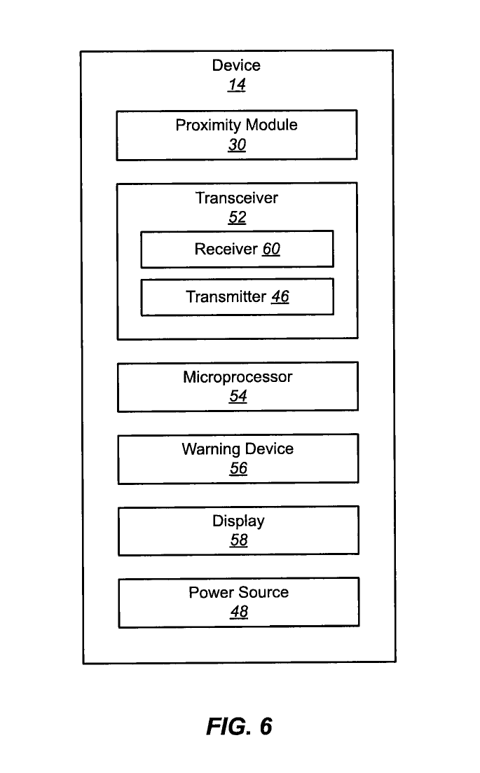

In another example, the device 14 includes additional components such as the same or similar components as the device 12. FIG. 6 shows the device 14 including a proximity module 30, a transceiver 52 having a receiver 60 and transmitter 46, a microprocessor 54, a warning device 56, a display 58, and a power source 48. The device 14 may be particularly suited for two-way communication with the device 12. The device 14 of FIG. 6 may provide the same or similar function as the device 12 described above.

The vehicle proximity warning system 10 may include any combination of the features of device 14 shown in FIGS. 5 and 6 for determining proximity of vehicles and communicating the proximity information to the driver of at least one of the vehicles to assist in helping the vehicles avoid accidents with each other.

An example method in accordance with the present disclosure includes providing a communication signal between two vehicles, determining proximity of the vehicles relative to each other based on the communication signal, and generating a warning signal for the driver of at least one of the vehicles when proximity of the vehicles is within a predetermined distance. At least one of the vehicles may be a haul truck used in the mining industry. At least one of the vehicles may be a vehicle that is smaller than a haul truck and must yield a right of way to haul trucks.

Another example method in accordance with the present disclosure includes sending a radio signal from one vehicle to another, automatically determining a distance between the vehicles based on the radio signal, and generating a warning signal to the driver of at least one of the vehicles when a minimum distance between vehicles is exceeded.

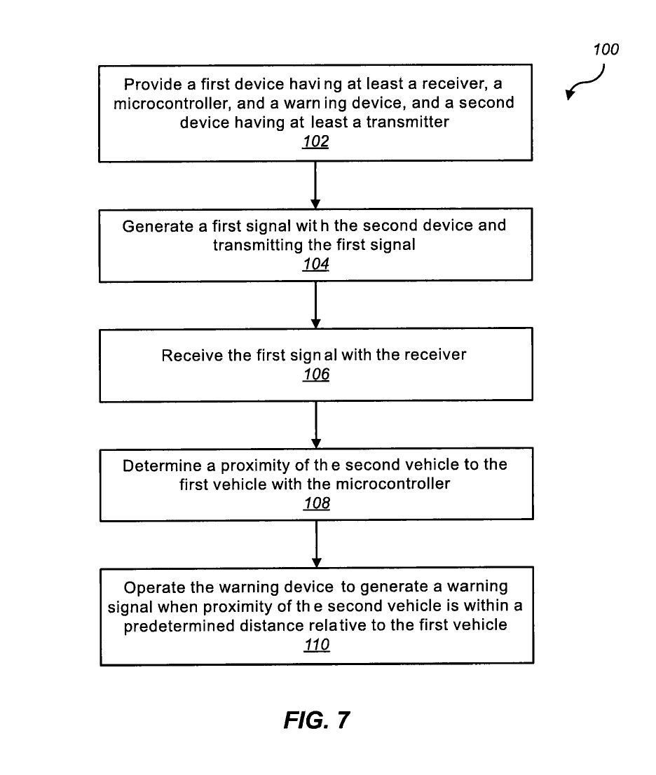

FIG. 7 shows an example method 100 in accordance with the present disclosure. Method 100 includes providing a first device having at least a receiver, a microcontroller, and a warning device, and a second device having at least a transmitter in a step 102. A step 104 includes generating a first signal with the second device and transmitting the first signal. Step 106 includes receiving the first signal with the receiver. Step 108 includes determining a proximity of the second vehicle to the first vehicle with the microcontroller. The warning device is operated to generate a warning signal when proximity of the second vehicle is within a predetermined distance relative to the first vehicle in a step 110.

Other steps of the method 100 may include providing the first signal as a unique signal for the second vehicle. The method may include providing the warning signal as at least one of a light, an inaudible noise, and a text or symbol shown on a display. The method may include providing the first device with a transmitter and the second device with a receiver, microcontroller and a warning device. The method may include generating a second signal with the first device and transmitting the second signal, receiving the second signal with the receiver of the second device, determining a proximity of the first vehicle to the second vehicle with the microcontroller of the second device, and operating the warning device of the second device to generate a warning signal when proximity of the first vehicle is within a predetermined distance relative to the second vehicle. The second signal may be unique to the vehicle. The method may include positioning the transmitter in a whip, which is carried by the second vehicle. The method may include transmitting the first signal as a radio signal.

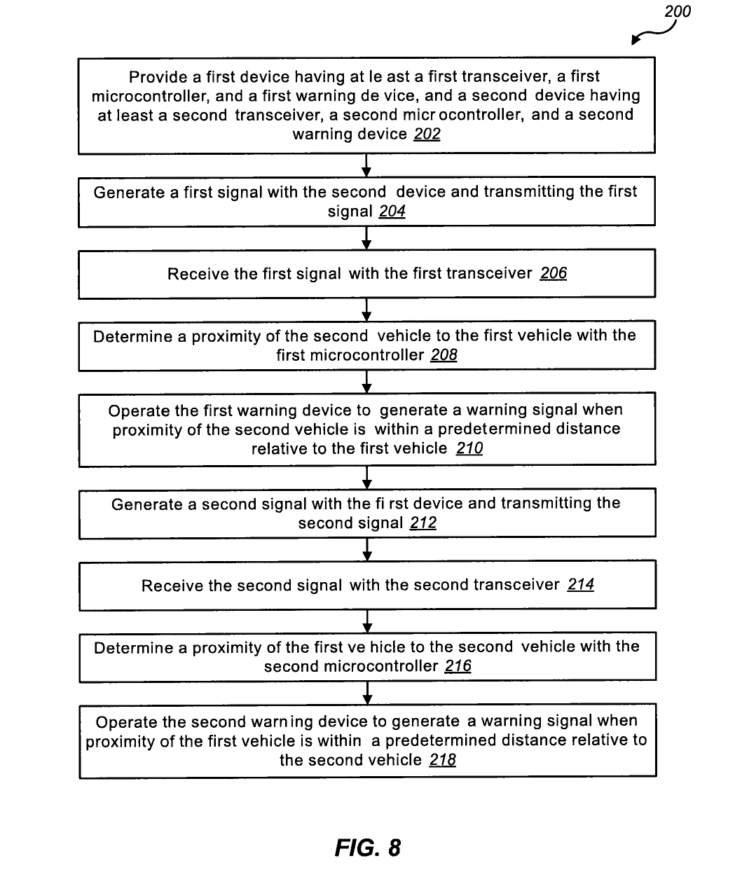

Referring to FIG. 8, another example method 200 includes providing a first device having at least a first transceiver, a first microcontroller, and a first warning device, and providing a second device having at least a second transceiver, a second microcontroller, and a second warning device in a step 202. Step 204 includes generating a first signal with the second device and transmitting the first signal, and a step 206 includes receiving the first signal with the first transceiver. A step 208 includes determining a proximity of the second vehicle to the first vehicle with the first microcontroller. A step 210 includes operating the first warning device to generate a warning signal when proximity of the second vehicle is within a predetermined distance relative to the first vehicle. A step 212 includes generating a second signal with the first device and transmitting the second signal, and a step 214 includes receiving the second signal with the second transceiver. A step 216 includes determining a proximity of the first vehicle to the second vehicle with the second microcontroller, and a step 218 includes operating the second warning device to generate a warning signal when proximity of the first vehicle is within a predetermined distance relative to the second vehicle.

The predetermined distance may vary depending on a number of factors. In one example, the predetermined distance is less than 200 ft., and more preferably less than about 100 ft. The predetermined distance may change depending on, for example, the speed of at least one of the vehicles. For example, when the speed of a first vehicle is relatively slow, the predetermined distance may be smaller (e.g., under 100 ft.). When the first vehicle is moving faster, the predetermined distance may increase (e.g., less than about 200 ft.). The predetermined distance may also vary depending on the direction in which the vehicles are moving. For example, if the first vehicle is moving in a rearward direction, the driver has even a smaller field of view than when driving forward, so the predetermined distance may be greater than when the first vehicle is moving forward. The proximity module may be programmed to take into account the many different variables that may be a factor for a given application of the vehicle proximity warning system 10.

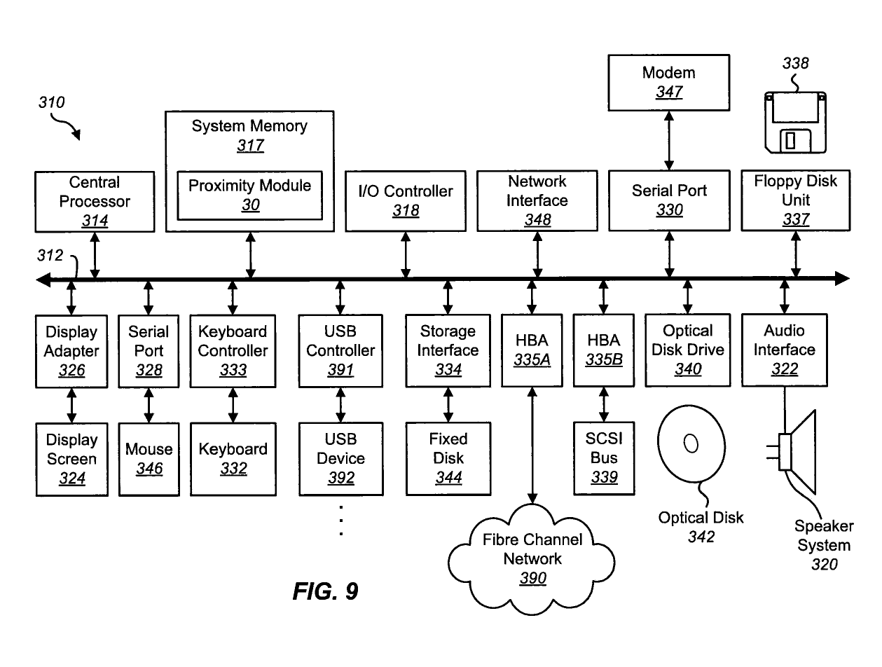

FIG. 9 depicts a block diagram of a computer system 310 suitable for implementing aspects of the present systems and methods. Computer system 310 includes a bus 312 which interconnects major subsystems of computer system 310, such as a central processor 314, a system memory 317 (typically RAM, but which may also include ROM, flash RAM, or the like), an input/output controller 318, an external audio device, such as a speaker system 320 via an audio output interface 322, an external device, such as a display screen 324 via display adapter 326, serial ports 328 and 330, a keyboard 332 (interfaced with a keyboard controller 333), a storage interface 334, a floppy disk drive 337 operative to receive a floppy disk 338, a host bus adapter (HBA) interface card 335A operative to connect with a Fibre Channel network 390, a host bus adapter (HBA) interface card 335B operative to connect to a SCSI bus 339, and an optical disk drive 340 operative to receive an optical disk 342. Also included are a mouse 346 (or other point-and-click device, coupled to bus 312 via serial port 328), a modem 347 (coupled to bus 312 via serial port 330), and a network interface 348 (coupled directly to bus 312).

Bus 312 allows data communication between central processor 314 and system memory 317, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a proximity module 30 or other functional component of proximity warning system 10 may be used to implement the present systems and methods may be stored within the system memory 317. Applications resident with computer system 310 are generally stored on and accessed via a computer readable medium, such as a hard disk drive (e.g., fixed disk 344), an optical drive (e.g., optical disk drive 340), a floppy disk drive 337, or other storage medium. Additionally, applications can be in the form of electronic signals modulated in accordance with the application and data communication technology when accessed via network modem 347 or interface 348.

Storage interface 334, as with the other storage interfaces of computer system 310, can connect to a standard computer readable medium for storage and/or retrieval of information, such as a fixed disk drive 344. Fixed disk drive 344 may be a part of computer system 310 or may be separate and accessed through other interface systems. Modem 347 may provide a direct connection to a remote server via a telephone link or to the Internet via an internet service provider (ISP). Network interface 348 may provide a direct connection to a remote server via a direct network link to the Internet via a POP (point of presence). Network interface 348 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 9 need not be present to practice the present disclosure. The devices and subsystems can be interconnected in different ways from that shown in FIG. 9. The operation of a computer system such as that shown in FIG. 9 is readily known in the art and is not discussed in detail in this application. Code to implement the present disclosure can be stored in computer-readable storage media such as one or more of system memory 317, fixed disk drive 344, optical disk 342, or floppy disk 338. The operating system provided on computer system 310 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

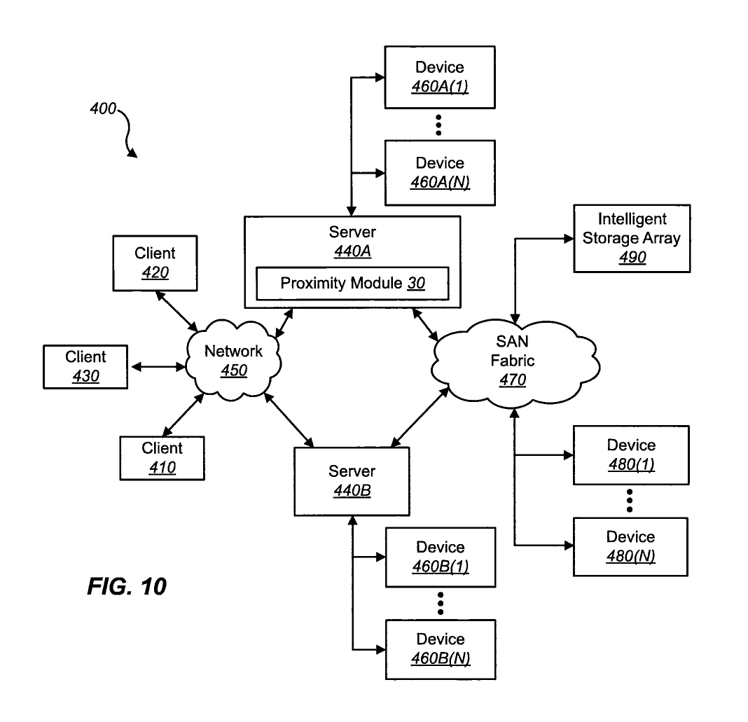

FIG. 10 is a block diagram depicting a network architecture 400 in which client systems 410, 420 and 430, as well as storage servers 440A and 440B (any of which can be implemented using client system 410), are coupled to a network 450. In one embodiment, the proximity module 30 or other functional component of proximity warning system 10 may be located within a server 440A, 440B to implement the present systems and methods. The storage server 440A is further depicted as having storage devices 460A(1)-(N) directly attached, and storage server 440B is depicted with storage devices 460B(1)-(N) directly attached. SAN fabric 470 supports access to storage devices 480(1)-(N) by storage servers 440A and 440B, and so by client systems 410, 420 and 430 via network 450. Intelligent storage array 490 is also shown as an example of a specific storage device accessible via SAN fabric 470.

With reference to computer system 310, modem 347, network interface 348 or some other method can be used to provide connectivity from each of client computer systems 410, 420 and 430 to network 450. Client systems 410, 420 and 430 are able to access information on storage server 440A or 440B using, for example, a web browser or other client software (not shown). Such a client allows client systems 410, 420 and 430 to access data hosted by storage server 440A or 440B or one of storage devices 460A(1)-(N), 460B(1)-(N), 480(1)-(N) or intelligent storage array 490. FIG. 10 depicts the use of a network such as the Internet for exchanging data, but the present disclosure is not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A vehicle proximity warning system, comprising:
a first device carried by a first vehicle, the first device comprising a first transceiver and a first warning device;
a second device carried by a second vehicle, the second device comprising a second transceiver and a second warning device;
wherein the first device determines proximity of the first vehicle relative to the second vehicle and generates a warning signal with the first warning device when the proximity is within a first predetermined distance, and the second device determines proximity of the second vehicle relative to the first vehicle and generates a warning signal with the second warning device when the proximity is within a second predetermined distance.

2. The vehicle proximity warning system of claim 1, wherein the first and second warning signals are one of a light, an audible noise, and a text or symbol on a display screen.

3. The vehicle proximity warning system of claim 1, wherein the second transceiver is positioned in a whip carried by the second vehicle.

4. The vehicle proximity warning system of claim 1, wherein the first predetermined distance is in a range of about 50 ft. to about 100 ft.

5. The vehicle proximity warning system of claim 1, wherein the first and second transceivers generate and receive one of a global position system (GPS) signal and a radio signal.

6. The vehicle proximity warning system of claim 1, wherein a signal generated by the first and second transceivers includes identification information about the first and second vehicles, respectively.

7. The vehicle proximity warning system of claim 1, wherein the first device determines a proximity of the first vehicle relative to the second vehicle when the second vehicle is located out of view of a driver of the first vehicle.

8. The vehicle proximity warning system, comprising:
a first device configured to be carried by a first vehicle, the first device comprising at least a receiver, a microcontroller, and a warning device;
a second device configured to be carried by a second vehicle, the second device comprising at least a transmitter configured to transmit a signal unique to the second vehicle;
wherein the receiver is configured to receive the signal, the microcontroller is configured to determine whether the second vehicle is within a predetermined distance relative to the first vehicle based on the signal, and the warning device generates a warning signal when the second vehicle is determined to be within the predetermined distance.

9. The vehicle proximity warning system of claim 8, wherein the warning signal includes identification information about the second vehicle.

10. The vehicle proximity warning system of claim 8, wherein the second device is configured to be carried by a whip, which is mounted to the second vehicle.

11. The vehicle proximity warning system of claim 8, wherein the signal is a radio signal.

12. The vehicle proximity warning system of claim 8, wherein the signal is a global position system (GPS) signal and the first device plots a position of the second vehicle on a display.

13. The vehicle proximity warning system of claim 8, wherein the first device includes a display, the display showing information about proximity of the second vehicle to the first vehicle.

14. The vehicle proximity warning system of claim 8, wherein the first device comprises a transmitter configured to transmit a signal to the second device.

15. The vehicle proximity warning system claim 8, wherein the second device is configured to be carried by a light fixture, which is mounted to the second vehicle.

16. A method of determining proximity between at least first and second vehicles, comprising:
providing a first device having at least a receiver, a microcontroller, and a warning device, and a second device having at least a transmitter;
generating a first signal with the second device and transmitting the first signal;
receiving the first signal with the receiver;
determining a proximity of the second vehicle to the first vehicle with the microcontroller;
operating the warning device to generate a warning signal when the second vehicle is within a predetermined distance relative to the first vehicle.

17. The method of claim 16, wherein the first signal is unique to the second vehicle.

18. The method of claim 16, wherein the warning signal is at least one of a light, an audible noise, and a text or symbol shown on a display.

19. The method of claim 16, wherein the first device comprises a transmitter, the second device comprises a receiver, a microcontroller and a warning device, the method further comprising:
generating a second signal with the first device and transmitting the second signal;
receiving the second signal with the receiver of the second device;
determining a proximity of the first vehicle to the second vehicle with the microcontroller of the second device;
operating the warning device of the second device to generate a warning signal when proximity of the first vehicle is within a predetermined distance relative to the second vehicle.

20. The method of claim 19, wherein the second signal is unique to the first vehicle.

21. The method of claim 16, further comprising positioning the transmitter in a whip, which is carried by the second vehicle.

22. The method of claim 16, further comprising transmitting the first signal as a radio signal.
